(19) United States
(12) Patent Application Publication
(10) Pub. No.: US 2025/0076335 A1
(43) Pub. Date: Mar. 6, 2025

(54) Sensor Module

(71) Applicant: SEIKO EPSON CORPORATION, Tokyo (JP)

(72) Inventor: Masayasu SAKUMA, Shiojiri (JP)

(21) Appl. No.: 18/820,457

(22) Filed: Aug. 30, 2024

(30) Foreign Application Priority Data
Aug. 31, 2023 (JP) 2023-141176

(51) Int. Cl. G01P 1/02; G01P 3/44

(52) U.S. Cl. CPC G01P 1/026; G01P 3/44

(57) ABSTRACT

A sensor module includes: a substrate having a first surface and a second surface that are in a front-back relationship with each other, and side surfaces including a first side surface; a first relay substrate having a first front surface and a first back surface and mounted on the first side surface with the first back surface facing the first side surface, the first front surface and the first back surface being in a front-back relationship with each other; and a first inertial sensor including a first package mounted on the first front surface of the first relay substrate and a first sensor element housed in the first package.

The present application is based on, and claims priority from JP Application Serial Number 2023-141176, filed Aug. 31, 2023, the disclosure of which is hereby incorporated by reference herein in its entirety.

### BACKGROUND

### 1. Technical Field

The present disclosure relates to a sensor module.

### 2. Related Art

An inertial measurement device described in JP-A-2017-020829 includes an inner case, a sensor substrate mounted on a lower surface of the inner case, and an outer case covering the inner case and housing the sensor substrate between the inner case and the outer case. The sensor substrate includes a substrate, a Z-axis angular velocity sensor, and an acceleration sensor mounted on an upper surface of the substrate, and an X-axis angular velocity sensor and a Y-axis angular velocity sensor mounted on side surfaces of the substrate.

Further, a recess is formed in the lower surface of the inner case, and the X-axis angular velocity sensor, the Y-axis angular velocity sensor, the Z-axis angular velocity sensor, and the acceleration sensors are arranged at positions overlapping the recess. In addition, the recess is filled with a filling member, the Z-axis angular velocity sensor and the acceleration sensor are entirely sealed with the filling member, and the upper halves of the X-axis angular velocity sensor and the Y-axis angular velocity sensor are sealed.

In the inertial measurement device of JP-A-2017-020829, the filling member is provided to reduce an influence of noise vibration from the outside and improve stability of detection accuracy.

However, in the inertial measurement device of JP-A-2017-020829, the X-axis angular velocity sensor and the Y-axis angular velocity sensor are mounted on the side surfaces of the substrate. Therefore, mounting reliability of the X-axis angular velocity sensor and the Y-axis angular velocity sensor is low, and there is a possibility that a detection characteristic changes over time.

### SUMMARY

According to an aspect of the present disclosure, a sensor module includes: a substrate having a first surface and a second surface that are in a front-back relationship with each other, and side surfaces including a first side surface; a first relay substrate having a first front surface and a first back surface and mounted on the first side surface with the first back surface facing the first side surface, the first front surface and the second back surface being in a front-back relationship with each other; and a first inertial sensor including a first package mounted on the first front surface of the first relay substrate and a first sensor element housed in the first package, in which α1>α2>α3, in which a thickness direction of the substrate is a first direction, α1 represents a linear expansion coefficient of the substrate in the first direction, α2 represents a linear expansion coefficient of the first relay substrate in the first direction, and α3 represents a linear expansion coefficient of the first package in the first direction.

### BRIEF DESCRIPTION OF THE DRAWINGS

FIG. 1 is a top view illustrating a sensor module according to a first embodiment.

FIG. 2 is an exploded perspective view of the sensor module.

FIG. 3 is a cross-sectional view taken along line A-A in FIG. 1.

FIG. 4 is a cross-sectional view taken along line B-B in FIG. 1.

FIG. 5 is a cross-sectional view of a first relay substrate.

FIG. 6 is a cross-sectional view of a second relay substrate.

FIG. 7 is a cross-sectional view of an angular velocity sensor.

FIG. 8 is a plan view of the angular velocity sensor.

FIG. 9 is a schematic diagram illustrating a driving state of the angular velocity sensor.

FIG. 10 is a schematic diagram illustrating the driving state of the angular velocity sensor.

FIG. 11 is a cross-sectional view of a first relay substrate according to a second embodiment.

FIG. 12 is a cross-sectional view of a second relay substrate according to the second embodiment.

FIG. 13 is a top view illustrating a sensor module according to a third embodiment.

FIG. 14 is a cross-sectional view taken along line C-C in FIG. 13.

FIG. 15 is a cross-sectional view taken along line D-D in FIG. 13.

FIG. 16 is a cross-sectional view of a first relay substrate according to a fourth embodiment.

FIG. 17 is a cross-sectional view of a second relay substrate according to the fourth embodiment.

### DESCRIPTION OF EMBODIMENTS

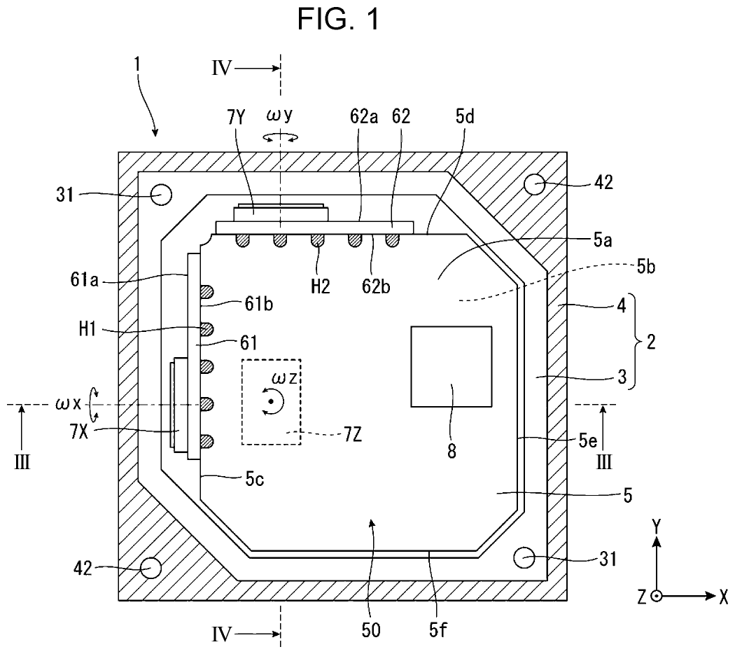

Hereinafter, a sensor module of the present disclosure will be described in detail based on embodiments illustrated in the accompanying drawings. For convenience of explanation, three mutually orthogonal axes are illustrated as an X axis, a Y axis, and a Z axis in FIGS. 1 to 6 and 11 to 17. Hereinafter, for convenience of explanation, a direction parallel to the X axis is referred to as an “X-axis direction”, a direction parallel to the Y axis is referred to as a “Y-axis direction”, and a direction parallel to the Z axis is referred to as a “Z-axis direction”. An arrow side of the Z-axis direction is referred to as an “upper side” and a side opposite thereto is referred to as a “lower side”.

### First Embodiment

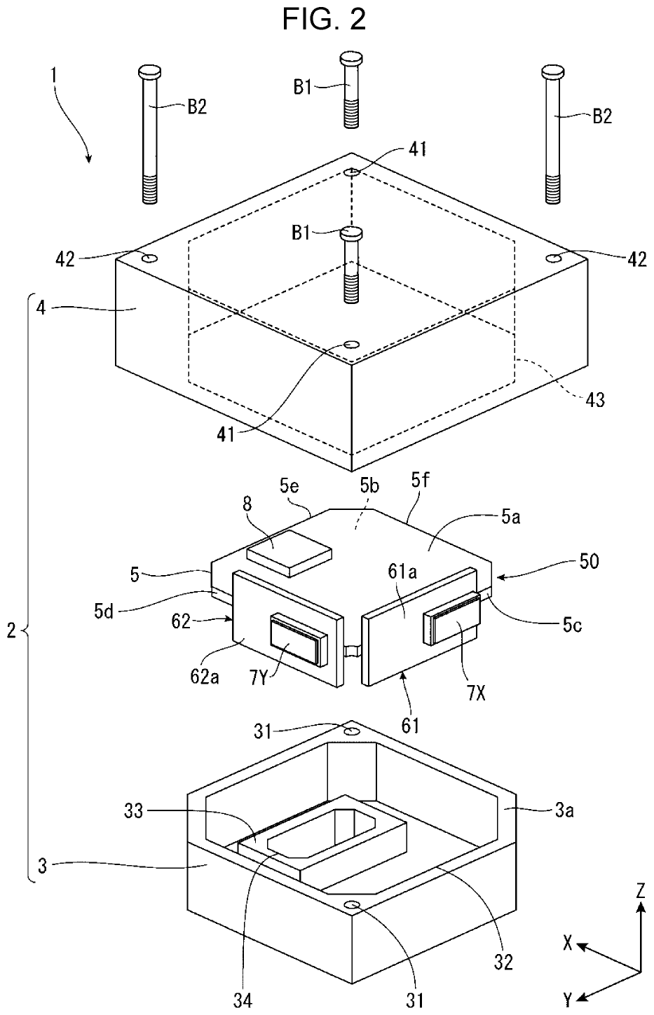

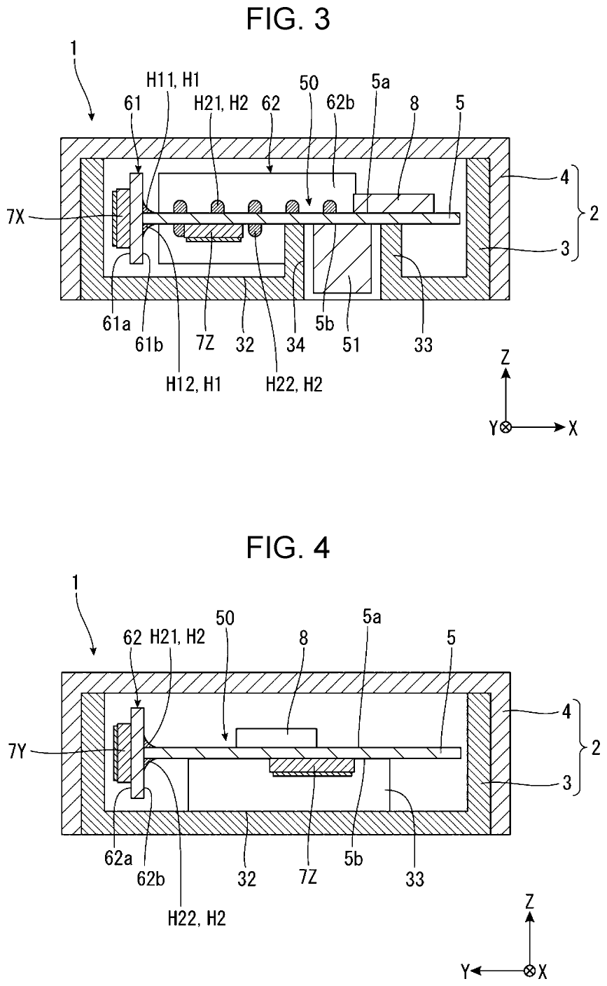

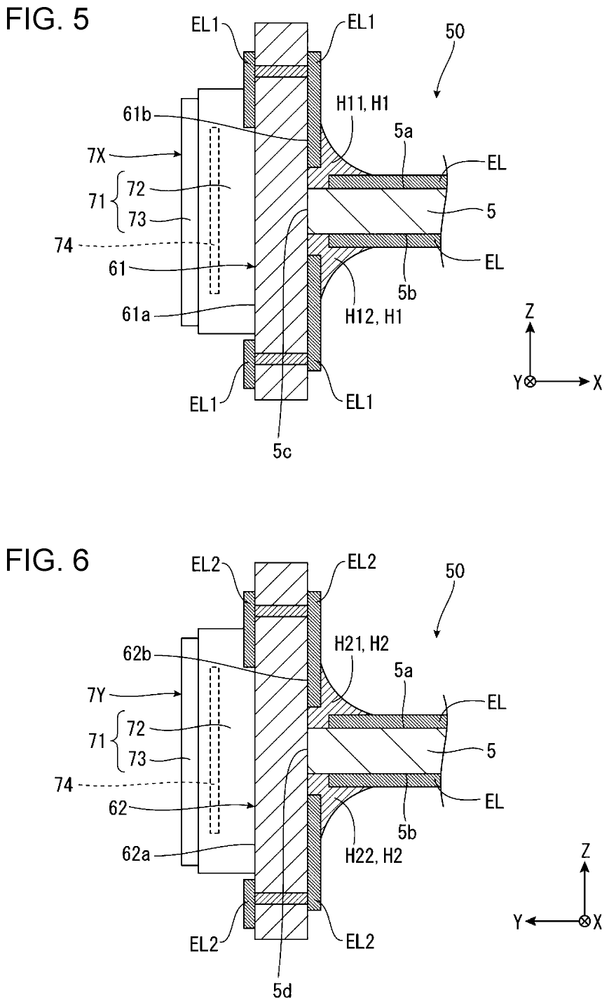

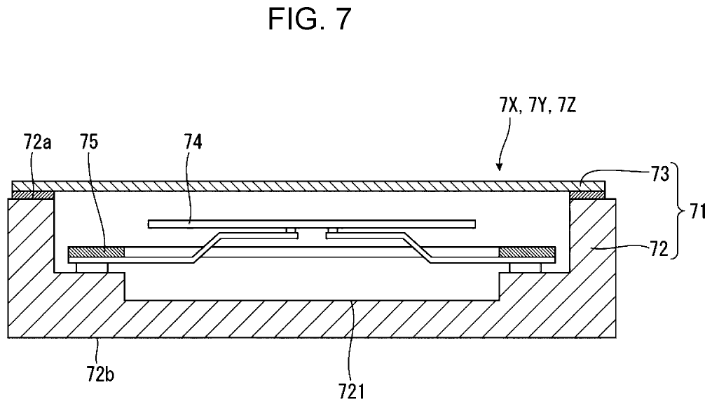

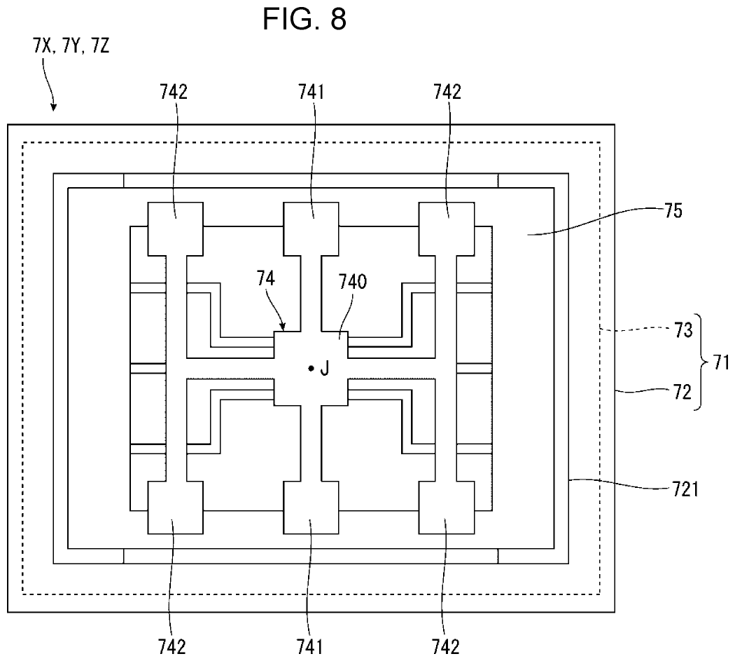

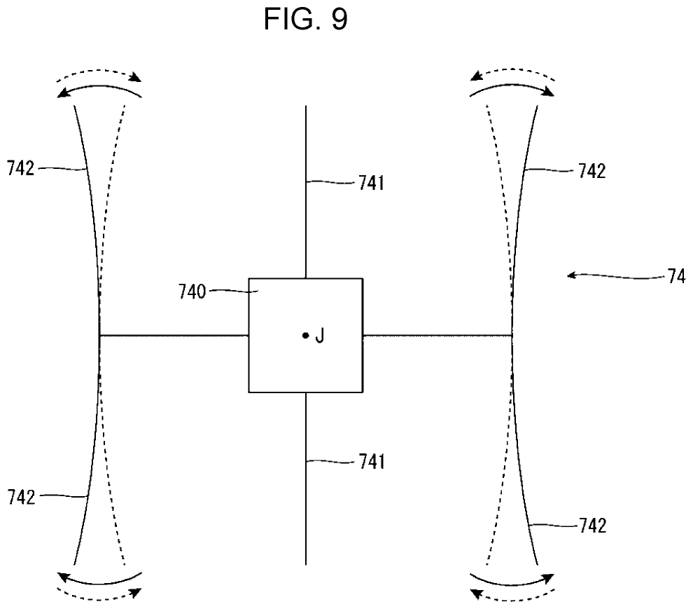

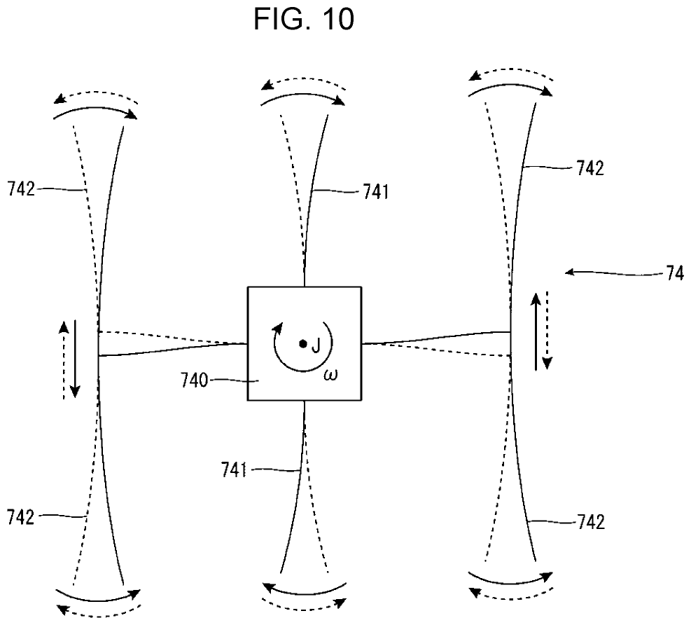

FIG. 1 is a top view illustrating a sensor module according to a first embodiment. FIG. 2 is an exploded perspective view of the sensor module. FIG. 3 is a cross-sectional view taken along line A-A in FIG. 1. FIG. 4 is a cross-sectional view taken along line B-B in FIG. 1. FIG. 5 is a cross-sectional view of a first relay substrate. FIG. 6 is a cross-sectional view of a second relay substrate. FIG. 7 is a cross-sectional view of an angular velocity sensor. FIG. 8 is a plan view of the angular velocity sensor. FIGS. 9 and 10 are schematic diagrams each illustrating a driving state of the angular velocity sensor.

A sensor module 1 illustrated in FIG. 1 is an inertial measurement unit (IMU) that detects a posture and a behavior of a mounted object such as an automobile or robot. The mounted object is not limited to moving bodies such as an automobile and a robot, and may be, for example, a structure such as a bridge, an elevated structure, or a track. When the sensor module 1 is attached to a structure, the sensor module 1 is used as a structural health monitoring system that checks soundness of the structure.

As illustrated in FIGS. 1 and 2, the sensor module 1 includes a case 2 and a sensor substrate 50 housed in the case 2.

### Case 2

As illustrated in FIGS. 1 and 2, the case 2 includes an inner case 3 and an outer case 4 arranged to cover the inner case 3. The inner case 3 and the outer case 4 are each made of aluminum. Therefore, the case 2 has a sufficiently high rigidity. In particular, in the present embodiment, surfaces of the inner case 3 and the outer case 4 are each anodized to provide insulation to the case 2. However, each of the materials of the inner case 3 and the outer case 4 is not particularly limited, and may be a metal material such as titanium, magnesium, or stainless steel, or ceramics such as alumina or titania.

The inner case 3 has a box shape whose upper side is opened, and has a rectangular parallelepiped shape of which two corners positioned on one diagonal line are chamfered. In addition, screw holes 31 for fixing the outer case 4 are formed at two corners positioned on the other diagonal line of the inner case 3.

The inner case 3 has a recess 32 that is open on an upper surface 3a. The inner case 3 includes a mounting base 33 that protrudes from a bottom surface of the recess 32 and on which the sensor substrate 50 is mounted. The inner case 3 has a through-hole 34 that penetrates through a lower surface of the inner case 3 and an upper surface of the mounting base 33. The through-hole 34 is a hole for exposing a connector 51 described below to the outside of the case 2.

The outer case 4 has a box shape whose lower side is opened, and has a rectangular parallelepiped shape. The outer case 4 covers the inner case 3 from above by inserting the inner case 3 into a recess 43 that is open on a lower surface of the outer case 4. An opening shape of the outer case 4 matches an outer shape of the inner case 3. Therefore, the outer case 4 is prevented from rattling relative to the inner case 3.

In addition, screw holes 41 that overlap the screw holes 31 are formed at two corners positioned on one diagonal line of the outer case 4. The inner case 3 and the outer case 4 are fixed by mounting screws B1 inserted through the screw holes 31 and 41. However, a method for fixing the outer case 4 to the inner case 3 is not particularly limited. Further, screw holes 42 are formed at two corners positioned on the other diagonal line of the outer case 4. Then, the sensor module 1 is mounted on the mounted object by mounting screws B2 inserted through the two screw holes 42. However, a method for mounting the sensor module 1 to the mounted object is not particularly limited.

### Sensor Substrate 50

As illustrated in FIGS. 1, 3 and 4, the sensor substrate 50 includes a substrate 5. The substrate 5 has an upper surface 5a serving as a first surface and a lower surface 5b serving as a second surface, which are in a front-back relationship with each other. Such a substrate 5 is mounted on the mounting base 33 of the inner case 3 with the lower surface 5b facing downward, and is screwed by screws (not illustrated). However, a method for fixing the substrate 5 to the inner case 3 is not particularly limited. Side surfaces of the substrate 5 include a first side surface 5c that faces a negative side in the X-axis direction, a third side surface 5e that faces the first side surface 5c and faces a positive side in the X-axis direction, a second side surface 5d that faces a positive side in the Y-axis direction, and a fourth side surface 5f that faces the second side surface 5d and faces a negative side in the Y-axis direction. Such a substrate 5 is a circuit board on which a wiring EL is formed, and is made of, for example, a multilayer glass epoxy substrate. However, a configuration of the substrate 5 is not particularly limited.

The sensor substrate 50 includes the connector 51 mounted on the lower surface 5b of the substrate 5. The sensor substrate 50 and an external device are electrically connected to each other via the connector 51.

As illustrated in FIG. 5, the sensor substrate 50 includes a first relay substrate 61 mounted on the first side surface 5c of the substrate 5. The first relay substrate 61 has a front surface 61a serving as a first front surface and a back surface 61b serving as a first back surface, which are in a front-back relationship with each other. The first relay substrate 61 is bonded to the first side surface 5c of the substrate 5 at the back surface 61b, with normal lines of the front surface 61a and the back surface 61b aligned with the X axis, that is, with the normal lines orthogonal to the substrate 5. Such a first relay substrate 61 is a circuit board on which wirings EL1 are formed, and is made of, for example, a multilayer glass epoxy board. In the present embodiment, the wiring EL1 formed on the front surface 61a and the wiring EL1 formed on the back surface are electrically connected to each other via a through electrode formed to penetrate through the first relay substrate 61.

In addition, the first relay substrate 61 is arranged to protrude upward and downward from the first side surface 5c in plan view of the first side surface 5c. With such a configuration, the first relay substrate 61 can be bonded to the substrate 5 from both an upper surface 5a side and a lower surface 5b side. Therefore, a bonding strength between the first relay substrate 61 and the substrate 5 can be increased.

Such a first relay substrate 61 is not only mechanically bonded but also electrically connected to the substrate 5 by a solder H1 serving as a first conductive portion. As a result, electrical connection between the first relay substrate 61 and the substrate 5 is facilitated. However, the first conductive portion is not particularly limited, and may be, for example, a conductive adhesive, a metal bump, or the like.

The solder H1 includes a plurality of fillet-shaped upper solders H11 formed across the upper surface 5a of the substrate 5 and the back surface 61b of the first relay substrate 61, and a plurality of fillet-shaped lower solders H12 formed across the lower surface 5b of the substrate 5 and the back surface 61b of the first relay substrate 61. In this way, the first relay substrate 61 is bonded to the substrate 5 from both the upper surface 5a side and the lower surface 5b side, so that the bonding strength between the first relay substrate 61 and the substrate 5 can be increased. However, a method for bonding the first relay substrate 61 to the substrate 5 is not particularly limited, and for example, either the upper solder H11 or the lower solder H12 may be omitted.

The sensor substrate 50 includes an X-axis angular velocity sensor 7X serving as a first inertial sensor mounted on the front surface 61a of the first relay substrate 61. The X-axis angular velocity sensor 7X is a sensor for detecting an angular velocity ox around the X axis.

As illustrated in FIG. 6, the sensor substrate 50 includes a second relay substrate 62 mounted on the second side surface 5d of the substrate 5. The second relay substrate 62 is a circuit board on which a wiring EL2 is formed, and is made of, for example, a multilayer glass epoxy board. However, a configuration of the second relay substrate 62 is not particularly limited. The second relay substrate 62 has a front surface 62a serving as a second front surface and a back surface 62b serving as a second back surface, which are in a front-back relationship with each other. The second relay substrate 62 is bonded to the second side surface 5d of the substrate 5 at the back surface 62b, with normal lines of the front surface 62a and the back surface 62b aligned with the Y axis, that is, with the normal lines orthogonal to the substrate 5 and the first relay substrate 61.

In addition, the second relay substrate 62 is arranged to protrude upward and downward from the second side surface 5d in plan view of the second side surface 5d. With such a configuration, the second relay substrate 62 can be bonded to the substrate 5 from both the upper surface 5a side and the lower surface 5b side. Therefore, a bonding strength between the second relay substrate 62 and the substrate 5 can be increased.

Such a second relay substrate 62 is not only mechanically bonded but also electrically connected to the substrate 5 by a solder H2 serving as a second conductive portion. As a result, electrical connection between the second relay substrate 62 and the substrate 5 is facilitated. However, the second conductive portion is not particularly limited, and may be, for example, a conductive adhesive, a metal bump, or the like.

The solder H2 includes a plurality of fillet-shaped upper solders H21 formed across the upper surface 5a of the substrate 5 and the back surface 62b of the second relay substrate 62, and a plurality of fillet-shaped lower solders H22 formed across the lower surface 5b of the substrate 5 and the back surface 62b of the second relay substrate 62. In this way, the second relay substrate 62 is bonded to the substrate 5 from both the upper surface 5a side and the lower surface 5b side, so that the bonding strength between the second relay substrate 62 and the substrate 5 can be increased. However, a method for bonding the second relay substrate 62 to the substrate 5 is not particularly limited, and for example, either the upper solder H21 or the lower solder H22 may be omitted.

The sensor substrate 50 includes a Y-axis angular velocity sensor 7Y serving as a second inertial sensor mounted on the front surface 62a of the second relay substrate 62. The Y-axis angular velocity sensor 7Y is a sensor for detecting an angular velocity wy around the Y axis.

As illustrated in FIG. 3, the sensor substrate 50 includes a Z-axis angular velocity sensor 7Z serving as a third inertial sensor mounted on the lower surface 5b of the substrate 5. The Z-axis angular velocity sensor 7Z is a sensor for detecting an angular velocity wz around the Z axis. In this way, the X-axis angular velocity sensor 7X, the Y-axis angular velocity sensor 7Y, and the Z-axis angular velocity sensor 7Z, that is, three inertial sensors, are provided, so that the sensor module 1 can measure more inertia, improving usability.

Each of the X-axis angular velocity sensor 7X, the Y-axis angular velocity sensor 7Y, and the Z-axis angular velocity sensor 7Z is a packaged surface-mounted component. Therefore, it is possible to exhibit a higher mechanical strength than those of components with exposed elements. Furthermore, it is easier to mount the X-axis angular velocity sensor 7X, the Y-axis angular velocity sensor 7Y, and the Z-axis angular velocity sensor 7Z on the substrate 5.

The X-axis angular velocity sensor 7X, the Y-axis angular velocity sensor 7Y, and the Z-axis angular velocity sensor 7Z have the same basic configuration, except that vibration frequencies of sensor elements 74 described below are different from each other to suppress an interference among the X-axis angular velocity sensor 7X, the Y-axis angular velocity sensor 7Y, and the Z-axis angular velocity sensor 7Z, and the X-axis angular velocity sensor 7X, the Y-axis angular velocity sensor 7Y, and the Z-axis angular velocity sensor 7Z are arranged orthogonal to each other in such a way that detection axes thereof face the X axis, the Y axis and the Z axis, respectively.

As illustrated in FIGS. 7 and 8, each of the X-axis angular velocity sensor 7X, the Y-axis angular velocity sensor 7Y, and the Z-axis angular velocity sensor 7Z includes a package 71 and the sensor element 74 housed in the package 71. The package 71 also includes a box-shaped base 72 having a recess 721 that is open on a front surface 72a and supporting the sensor element 74 housed in the recess 721, and a lid 73 bonded to the base 72 in such a way as to close an opening of the recess 721. A connection terminal (not illustrated) electrically connected to the sensor element 74 is formed on a back surface 72b of the base 72.

In the present embodiment, the package 71 of the X-axis angular velocity sensor 7X is a first package, and the sensor element 74 of the X-axis angular velocity sensor 7X is a first sensor element. The package 71 of the Y-axis angular velocity sensor 7Y is a second package, and the sensor element 74 of the Y-axis angular velocity sensor 7Y is a second sensor element.

The X-axis angular velocity sensor 7X is bonded to the front surface 61a of the first relay substrate 61 on the back surface 72b of the base 72, and is electrically connected to the first relay substrate 61 via the connection terminal. The Y-axis angular velocity sensor 7Y is bonded to the front surface 62a of the second relay substrate 62 on the back surface 72b of the base 72, and is electrically connected to the second relay substrate 62 via the connection terminal. The Z-axis angular velocity sensor 7Z is bonded to the lower surface 5b of the substrate 5 on the back surface 72b of the base 72, and is electrically connected to the substrate 5 via a connection terminal.

The sensor element 74 is, for example, a quartz crystal vibration element having drive vibration arms and detection vibration arms. In the configuration in FIG. 8, the sensor element 74 includes a base portion 740 fixed to the base 72 via a support substrate 75, four drive vibration arms 742, and two detection vibration arms 741. In such a quartz crystal vibration element, when an angular velocity @ around a detection axis J is applied in a state in which the drive vibration arms 742 are driven to vibrate according to an applied drive signal as illustrated in FIG. 9, the detection vibration is excited in the detection vibration arms 741 by the Coriolis force as illustrated in FIG. 10. Then, a charge generated in the detection vibration arms 741 by the detection vibration is extracted as a detection signal, and the angular velocity @ can be obtained based on the extracted detection signal.

The configurations of the X-axis angular velocity sensor 7X, the Y-axis angular velocity sensor 7Y, and the Z-axis angular velocity sensor 7Z have been described above. The X-axis angular velocity sensor 7X is arranged in such a way that the detection axis J is along the X axis, the Y-axis angular velocity sensor 7Y is arranged in such a way that the detection axis J is along the Y axis, and the Z-axis angular velocity sensor 7Z is arranged in such a way that the detection axis J is along the Z axis. However, the configurations of the X-axis angular velocity sensor 7X, the Y-axis angular velocity sensor 7Y, and the Z-axis angular velocity sensor 7Z are not particularly limited. For example, a silicon micro-electromechanical systems (MEMS) vibration element may be used as the sensor element.

As illustrated in FIG. 1, the sensor substrate 50 includes a circuit element 8 serving as an electronic component mounted on the upper surface 5a of the substrate 5. The circuit element 8 is electrically connected to the X-axis angular velocity sensor 7X, the Y-axis angular velocity sensor 7Y, the Z-axis angular velocity sensor 7Z, and the connector 51 via the substrate 5. The circuit element 8 is, for example, a micro controller unit (MCU), and controls each part of the sensor module 1. Specifically, the circuit element 8 includes a control circuit that controls the driving of the X-axis angular velocity sensor 7X, the Y-axis angular velocity sensor 7Y, and the Z-axis angular velocity sensor 7Z, and an interface circuit that communicates with the outside.

The control circuit independently controls the driving of the X-axis angular velocity sensor 7X, the Y-axis angular velocity sensor 7Y, and the Z-axis angular velocity sensor 7Z, and independently detects an angular velocity around each of the X axis, the Y axis, and the Z axis based on the detection signals output from the X-axis angular velocity sensor 7X, the Y-axis angular velocity sensor 7Y, and the Z-axis angular velocity sensor 7Z. The interface circuit transmits and receives a signal to receive a command from an external device via the connector 51 and output the detected angular velocity to an external device. A communication method of the interface circuit is not particularly limited, but the communication method of the interface circuit may be serial peripheral interface (SPI) communication in the present embodiment. The SPI communication is a communication method suitable for connecting a plurality of sensors. Since all signals related to the angular velocity can be output from one pin, it is possible to reduce the number of pins of the sensor module 1.

In actual implementation, in addition to the X-axis angular velocity sensor 7X, the Y-axis angular velocity sensor 7Y, the Z-axis angular velocity sensor 7Z, and the circuit element 8 described above, a plurality of electronic components are mounted on the substrate 5, but the electronic components will not be illustrated and described for convenience of explanation.

Here, in the sensor module 1, α1>α2>α3, in which α1 represents a linear expansion coefficient in a thickness direction of the substrate 5, that is, the Z-axis direction as a first direction, α2 represents a linear expansion coefficient in a planar direction of the first relay substrate 61, that is, the Z-axis direction along the thickness direction of the substrate 5, and α3 represents a linear expansion coefficient in a planar direction of the package 71 of the X-axis angular velocity sensor 7X, specifically, the base 72, that is, the Z-axis direction along the thickness direction of the substrate 5. In the present embodiment, α1 is about 40 ppm/° C., α2 is 12 ppm/° C., and α3 is about 7 ppm/° C. However, the values of α1, α2, and 3 are not particularly limited as long as α1>α2>α3.

As α1>α2>α3, mounting reliability of the X-axis angular velocity sensor 7X is improved. Specifically, when the X-axis angular velocity sensor 7X is directly mounted on the first side surface 5c of the substrate 5 as in the related art, a difference between the linear expansion coefficients α1 and α3 is large, as a result of which a large thermal stress may be generated at a bonded portion between the X-axis angular velocity sensor 7X and the substrate 5, and the solder H1 may peel off or crack. In contrast, when the first relay substrate 61 having the linear expansion coefficient α2 between the linear expansion coefficients α1 and α3 is interposed between the substrate 5 and the X-axis angular velocity sensor 7X as in the present embodiment, the thermal stress can be distributed to a bonded portion between the substrate 5 and the first relay substrate 61 and a bonded portion between the first relay substrate 61 and the X-axis angular velocity sensor 7X. Therefore, the thermal stress applied to one bonded portion is reduced, peeling or cracking of the solder H1 is effectively suppressed, thereby improving the mounting reliability.

Although not illustrated, various circuit elements for the X-axis angular velocity sensor 7X, such as a capacitor, a regulator, and a power supply circuit, can also be mounted on the first relay substrate 61. As a result, it is possible to easily mount the circuit element for the X-axis angular velocity sensor 7X near the X-axis angular velocity sensor 7X, thereby improving a circuit characteristic.

In the sensor module 1, similarly to the first relay substrate 61 as described above, α1>α4>α5, in which α4 represents a linear expansion coefficient in a planar direction of the second relay substrate 62, that is, the Z-axis direction along the thickness direction of the substrate 5, and α5 represents a linear expansion coefficient in a planar direction of the package 71 of the Y-axis angular velocity sensor 7Y, specifically, in a planar direction of the base 72, that is, the Z-axis direction along the thickness direction of the substrate 5. In the present embodiment, α4=α2, and α5=α3. However, the values of α4 and α5 are not particularly limited. As α1>α4>α5, mounting reliability of the Y-axis angular velocity sensor 7Y is improved. Specifically, when the Y-axis angular velocity sensor 7Y is directly mounted on the second side surface 5d of the substrate 5 as in the related art, a difference between the linear expansion coefficients α1 and α5 is large, as a result of which a large thermal stress may be generated at a bonded portion between the Y-axis angular velocity sensor 7Y and the substrate 5, and the solder H2 may peel off or crack. In contrast, when the second relay substrate 62 having the linear expansion coefficient α4 between the linear expansion coefficients α1 and α5 is interposed between the substrate 5 and the Y-axis angular velocity sensor 7Y as in the present embodiment, the thermal stress can be distributed to a bonded portion between the substrate 5 and the second relay substrate 62 and a bonded portion between the second relay substrate 62 and the Y-axis angular velocity sensor 7Y. Therefore, the thermal stress applied to one bonded portion is reduced, peeling or cracking of the solder H2 is effectively suppressed, thereby improving the mounting reliability.

Although not illustrated, various circuit elements for the Y-axis angular velocity sensor 7Y, such as a capacitor, a regulator, and a power supply circuit, can also be mounted on the second relay substrate 62. As a result, it is possible to easily mount the circuit element for the Y-axis angular velocity sensor 7Y near the Y-axis angular velocity sensor 7Y, thereby improving a circuit characteristic.

The sensor module 1 of the present embodiment has been described above. As described above, the sensor module 1 includes the substrate 5 having the upper surface 5a serving as the first surface, the lower surface 5b serving as the second surface, and the side surfaces including the first side surface 5c, the upper surface 5a and the lower surface 5b being in a front-back relationship with each other, the first relay substrate 61 having the front surface 61a serving as the first front surface and the back surface 61b serving as the first back surface, and mounted on the first side surface 5c with the back surface 61b facing the first side surface 5c, and the X-axis angular velocity sensor 7X serving as the first inertial sensor including the package 71 serving as the first package mounted on the front surface 61a of the first relay substrate 61, and the sensor element 74 serving as the first sensor element housed in the package 71. α1>α2>α3, in which the thickness direction of the substrate 5 is the first direction, that is, the Z-axis direction, α1 represents the linear expansion coefficient of the substrate 5 in the Z-axis direction, α2 represents the linear expansion coefficient of the first relay substrate 61 in the Z-axis direction, and α3 represents the linear expansion coefficient of the package 71 of the X-axis angular velocity sensor 7X in the Z-axis direction. In this way, when the first relay substrate 61 having the linear expansion coefficient α2 between the linear expansion coefficients α1 and α3 is interposed between the substrate 5 and the X-axis angular velocity sensor 7X, the thermal stress caused by the difference in linear expansion coefficient can be distributed to the bonded portion between the substrate 5 and the first relay substrate 61 and the bonded portion between the first relay substrate 61 and the X-axis angular velocity sensor 7X. Therefore, it becomes difficult for stress to concentrate, improving the mounting reliability.

As described above, the side surfaces of the substrate 5 further include the second side surface 5d different from the first side surface 5c. The sensor module 1 includes the second relay substrate 62 having the front surface 62a serving as the second front surface and the back surface 62b serving as the second back surface, and mounted on the second side surface 5d with the back surface 62b facing the second side surface 5d, the front surface 62a and the back surface 62b being in a front-back relationship with each other, and the Y-axis angular velocity sensor 7Y serving as the second inertial sensor including the package 71 serving as the second package mounted on the front surface 62a of the second relay substrate 62, and the sensor element 74 serving as the second sensor element housed in the package 71. α1>α4>α5, in which α4 represents the linear expansion coefficient in the Z-axis direction of the second relay substrate 62, and α5 represents the linear expansion coefficient in the Z-axis direction of the package 71 of the Y-axis angular velocity sensor 7Y. In this way, when the second relay substrate 62 having the linear expansion coefficient α4 between the linear expansion coefficients α1 and α5 is interposed between the substrate 5 and the Y-axis angular velocity sensor 7Y, the thermal stress caused by the difference in linear expansion coefficient can be distributed to the bonded portion between the substrate 5 and the second relay substrate 62 and the bonded portion between the second relay substrate 62 and the Y-axis angular velocity sensor 7Y. Therefore, it becomes difficult for stress to concentrate, improving the mounting reliability.

As described above, the sensor module 1 includes the Z-axis angular velocity sensor 7Z serving as the third inertial sensor mounted on the upper surface 5a or the lower surface 5b of the substrate 5. Therefore, the sensor module 1 can measure more inertia.

As described above, the first relay substrate 61 protrudes from the first side surface 5c toward the upper surface 5a and the lower surface 5b in plan view of the first side surface 5c, and the second relay substrate 62 protrudes from the second side surface 5d toward the upper surface 5a and the lower surface 5b in plan view of the second side surface 5d. Therefore, the first relay substrate 61 can be bonded to the substrate 5 from both the upper surface 5a side and the lower surface 5b side. Therefore, the bonding strength between the first relay substrate 61 and the substrate 5 can be increased. Similarly, the second relay substrate 62 can be bonded to the substrate 5 from both the upper surface 5a side and the lower surface 5b side. Therefore, the bonding strength between the second relay substrate 62 and the substrate 5 can be increased.

As described above, the first relay substrate 61 is electrically connected to the substrate 5 via the solder H1 serving as the first conductive portion, and the second relay substrate 62 is electrically connected to the substrate 5 via the solder H2 serving as the second conductive portion. As a result, electrical connection between the first relay substrate 61 and the substrate 5 is facilitated. Similarly, electrical connection between the second relay substrate 62 and the substrate 5 is facilitated.

### Second Embodiment

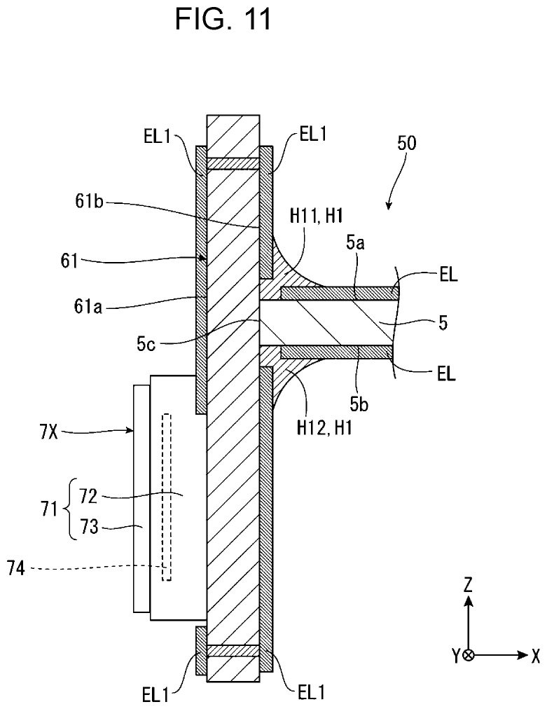

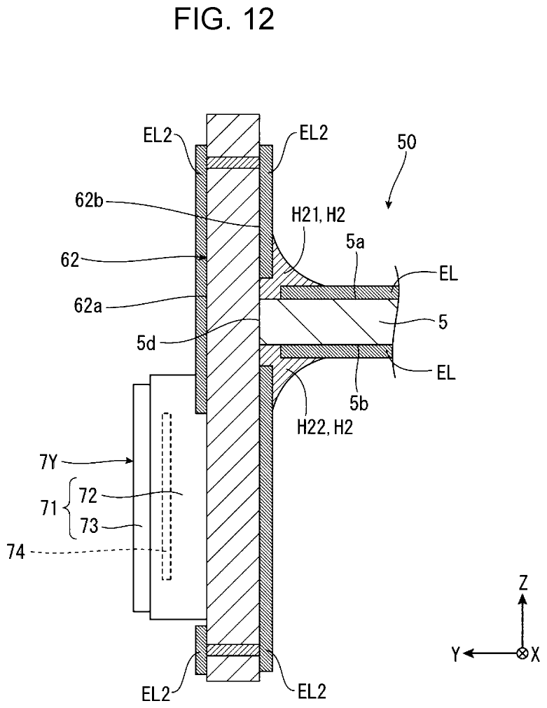

FIG. 11 is a cross-sectional view of a first relay substrate according to a second embodiment. FIG. 12 is a cross-sectional view of a second relay substrate according to the second embodiment.

The present embodiment is similar to the first embodiment described above, except that a position of an X-axis angular velocity sensor 7X on a first relay substrate 61 and a position of a Y-axis angular velocity sensor 7Y on a second relay substrate 62 are different. In the following description, differences between the present embodiment and the first embodiment described above will be mainly described, and a description of the similar matters will be omitted. In addition, in each drawing of the present embodiment, the same components as those in the above-described embodiment are denoted by the same reference numerals.

As illustrated in FIG. 11, in the present embodiment, the X-axis angular velocity sensor 7X is arranged at a distance from a first side surface 5c in plan view of the first side surface 5c, that is, in plan view from the X-axis direction. That is, in FIG. 11, the X-axis angular velocity sensor 7X is arranged to be shifted toward the negative side in the Z-axis direction in such a way as not to overlap the first side surface 5c unlike FIG. 5. Since the first relay substrate 61 is mounted on the first side surface 5c, a large thermal stress is applied to a position where the first relay substrate 61 overlaps the first side surface 5c. Therefore, the thermal stress is less likely to be transferred to the X-axis angular velocity sensor 7X by arranging the X-axis angular velocity sensor 7X in such a way as not to overlap the first side surface 5c as in the present embodiment. Therefore, deterioration of a detection characteristic of the X-axis angular velocity sensor 7X can be more effectively suppressed. In the present embodiment, the X-axis angular velocity sensor 7X is arranged to be shifted downward with respect to the first side surface 5c, but is not limited thereto. The X-axis angular velocity sensor 7X may be arranged to be shifted upward with respect to the first side surface 5c, for example.

Similarly, as illustrated in FIG. 12, the Y-axis angular velocity sensor 7Y is arranged at a distance from a second side surface 5d in plan view of the second side surface 5d, that is, in plan view from the Y-axis direction. That is, in FIG. 12, the Y-axis angular velocity sensor 7Y is arranged to be shifted toward the negative side in the Z-axis direction in such a way as not to overlap the second side surface 5d unlike FIG. 6. Since the second relay substrate 62 is mounted on the second side surface 5d, a large thermal stress is applied to a position where the second relay substrate 62 overlaps the second side surface 5d. Therefore, the thermal stress is less likely to be transferred to the Y-axis angular velocity sensor 7Y by arranging the Y-axis angular velocity sensor 7Y in such a way as not to overlap the second side surface 5d as in the present embodiment. Therefore, deterioration of a detection characteristic of the Y-axis angular velocity sensor 7Y can be more effectively suppressed. In the present embodiment, the Y-axis angular velocity sensor 7Y is arranged to be shifted downward with respect to the second side surface 5d, but is not limited thereto. The Y-axis angular velocity sensor 7Y may be arranged to be shifted upward with respect to the second side surface 5d, for example.

In the sensor module 1 as described above, the X-axis angular velocity sensor 7X is arranged at a distance from the first side surface 5c in plan view of the first side surface 5c, and the Y-axis angular velocity sensor 7Y is arranged at a distance from the second side surface 5d in plan view of the second side surface 5d. Therefore, it becomes difficult for the thermal stress to be transferred to the X-axis angular velocity sensor 7X and the Y-axis angular velocity sensor 7Y. Therefore, the deterioration of the detection characteristics of the X-axis angular velocity sensor 7X and the Y-axis angular velocity sensor 7Y can be more effectively suppressed.

The second embodiment as described above can also achieve the same effect as the first embodiment.

### Third Embodiment

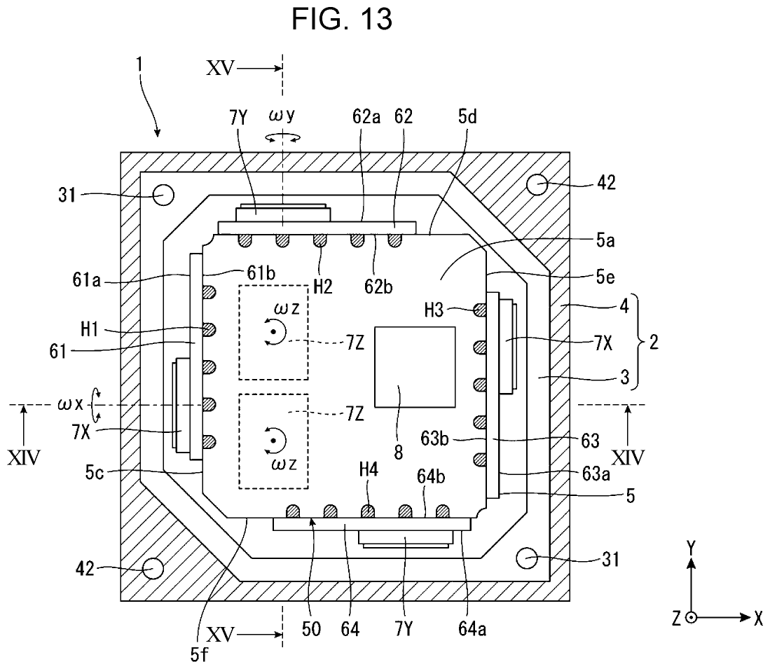

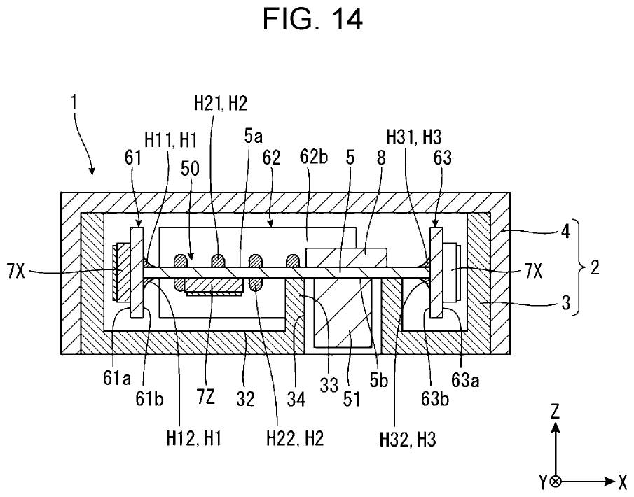

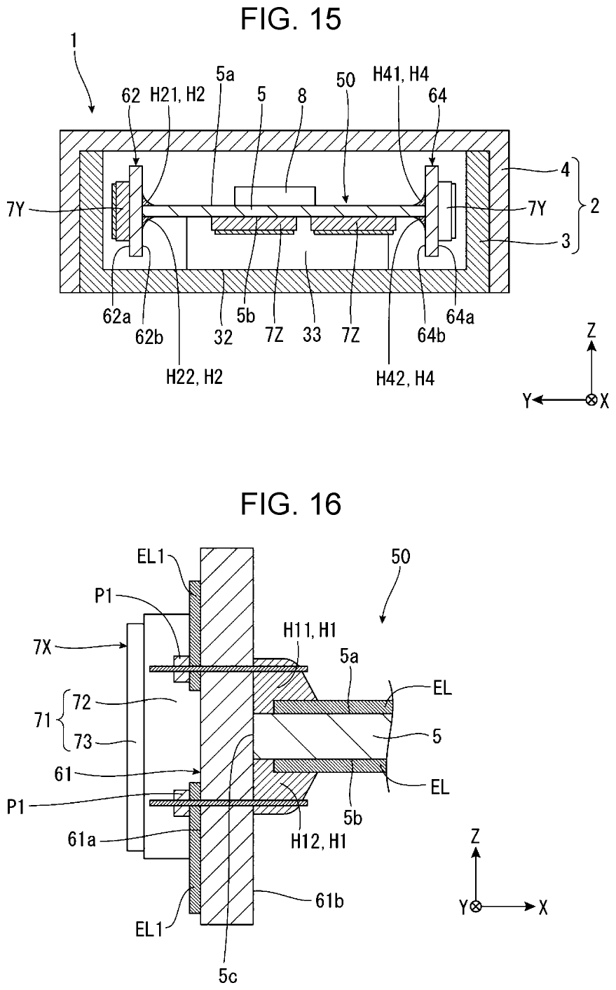

FIG. 13 is a top view illustrating a sensor module according to a third embodiment. FIG. 14 is a cross-sectional view taken along line C-C in FIG. 13. FIG. 15 is a cross-sectional view taken along line D-D in FIG. 13.

The present embodiment is the same as the first embodiment described above, except that a configuration of a sensor substrate 50 is different. In the following description, differences between the present embodiment and the first embodiment described above will be mainly described, and a description of the similar matters will be omitted. In addition, in each drawing of the present embodiment, the same components as those in the above-described embodiment are denoted by the same reference numerals.

As illustrated in FIGS. 13 to 15, the sensor substrate 50 of the present embodiment includes a third relay substrate 63 mounted on a third side surface 5e and a fourth relay substrate 64 mounted on a fourth side surface 5f. The third and fourth relay substrates 63 and 64 are circuit boards and have the same configurations as first and second relay substrates 61 and 62, respectively. Further, the third and fourth relay substrates 63 and 64 are mounted on a substrate 5 in the same manner as the first and second relay substrates 61 and 62, respectively. By mounting the third and fourth relay substrates 63 and 64 in this way, for example, a space available for mounting circuit elements is increased compared to the first embodiment described above, and therefore the degree of freedom in design is increased. In addition, for example, the substrate 5 can be reduced in size by mounting all or some of the circuit elements mounted on the substrate 5 in the first embodiment on the third and fourth relay substrates 63 and 64.

The third relay substrate 63 has a front surface 63a serving as a third front surface and a back surface 63b serving as a third back surface, which are in a front-back relationship with each other. The third relay substrate 63 is bonded to the third side surface 5e of the substrate 5 at the back surface 63b, with normal lines of the front surface 63a and the back surface 63b aligned with the X axis, that is, with the normal lines parallel to the first relay substrate 61. In addition, the third relay substrate 63 is arranged to protrude upward and downward from the third side surface 5e in plan view of the third side surface 5e. Such a third relay substrate 63 is not only mechanically bonded but also electrically connected to the substrate 5 by a solder H3 serving as a third conductive portion. The solder H3 includes a plurality of fillet-shaped upper solders H31 formed across an upper surface 5a of the substrate 5 and the back surface 63b of the third relay substrate 63, and a plurality of fillet-shaped lower solders H32 formed across a lower surface 5b of the substrate 5 and the back surface 63b of the third relay substrate 63.

The sensor substrate 50 includes an X-axis angular velocity sensor 7X serving as a third inertial sensor mounted on the front surface 63a of the third relay substrate 63. That is, the sensor substrate 50 of the present embodiment includes a pair of X-axis angular velocity sensors 7X. With such a configuration, an angular velocity wx is detected based on a detection signal output from each X-axis angular velocity sensor 7X, so that noise is reduced compared to the first embodiment described above, and the angular velocity ox can be detected more accurately. The detection signal output from the X-axis angular velocity sensor 7X mounted on the front surface 63a of the third relay substrate 63 may be calculated together with the detection signal output from the X-axis angular velocity sensor 7X mounted on a front surface 61a of the first relay substrate 61. The calculation processing may be executed by a micro controller unit (MCU) serving as a circuit element 8, or may be averaging processing.

The fourth relay substrate 64 has a front surface 64a serving as a fourth front surface and a back surface 64b serving as a fourth back surface, which are in a front-back relationship with each other. The fourth relay substrate 64 is bonded to the fourth side surface 5f of the substrate 5 at the back surface 64b, with normal lines of the front surface 64a and the back surface 64b aligned with the Y axis, that is, with the normal lines parallel to the second relay substrate 62. In addition, the fourth relay substrate 64 is arranged to protrude upward and downward from the fourth side surface 5f in plan view of the fourth side surface 5f. Such a fourth relay substrate 64 is not only mechanically bonded but also electrically connected to the substrate 5 by a solder H4 serving as a fourth conductive portion. The solder H4 includes a plurality of fillet-shaped upper solders H41 formed across the upper surface 5a of the substrate 5 and the back surface 64b of the fourth relay substrate 64, and a plurality of fillet-shaped lower solders H42 formed across the lower surface 5b of the substrate 5 and the back surface 64b of the fourth relay substrate 64.

The sensor substrate 50 includes a Y-axis angular velocity sensor 7Y serving as a fourth inertial sensor mounted on the front surface 64a of the fourth relay substrate 64. That is, the sensor substrate 50 of the present embodiment includes a pair of Y-axis angular velocity sensors 7Y. With such a configuration, an angular velocity ωy is detected based on a detection signal output from each Y-axis angular velocity sensor 7Y, so that noise is reduced compared to the first embodiment described above, and the angular velocity ωy can be detected more accurately. The detection signal output from the Y-axis angular velocity sensor 7Y mounted on the front surface 64a of the fourth relay substrate 64 may be calculated together with the detection signal output from the Y-axis angular velocity sensor 7Y mounted on a front surface 62a of the second relay substrate 62. The calculation processing may be executed by a micro controller unit (MCU) serving as a circuit element 8, or may be averaging processing.

The sensor substrate 50 includes a pair of Z-axis angular velocity sensors 7Z mounted on the lower surface 5b of the substrate 5. With such a configuration, an angular velocity ωz is detected based on a detection signal output from each Z-axis angular velocity sensor 7Z, so that noise is reduced compared to the first embodiment described above, and the angular velocity ωz can be detected more accurately. The detection signals output from the pair of Z-axis angular velocity sensors 7Z mounted on the lower surface 5b of the substrate 5 may be calculated. The calculation processing may be executed by a micro controller unit (MCU) serving as a circuit element 8, or may be averaging processing.

In the sensor module 1 described above, side surfaces of the substrate 5 further include the third side surface 5e facing a first side surface 5c and the fourth side surface 5f facing a second side surface 5d. The sensor module 1 includes the third relay substrate 63 having the front surface 63a serving as the third surface and the back surface 63b serving as the third back surface, and mounted on the third side surface 5e with the back surface 63b facing the third side surface 5e, the front surface 63a and the back surface 63b being in a front-back relationship with each other, the X-axis angular velocity sensor 7X serving as the third inertial sensor mounted on the front surface 63a of the third relay substrate 63, the fourth relay substrate 64 having the front surface 64a serving as the fourth surface and the back surface 64b serving as the fourth back surface, and mounted on the fourth side surface 5f with the back surface 64b facing the fourth side surface 5f, the front surface 64a and the back surface 64b being in a front-back relationship with each other, and the Y-axis angular velocity sensor 7Y serving as the fourth inertial sensor mounted on the front surface 64a of the fourth relay substrate 64. With such a configuration, for example, a space available for mounting the circuit elements is increased compared to the first embodiment described above, and therefore the degree of freedom in design is increased. For example, by mounting all or some of the circuit elements mounted on the substrate 5 in the first embodiment on the third and fourth relay substrates 63 and 64, the substrate 5 can be reduced in size. The angular velocity ox is detected based on the detection signal output from each X-axis angular velocity sensor 7X, so that noise is reduced, and the angular velocity wx can be detected more accurately. Similarly, the angular velocity ωy is detected based on the detection signal output from each Y-axis angular velocity sensor 7Y, so that noise is reduced, and the angular velocity ωy can be detected more accurately.

The third embodiment as described above can also achieve the same effect as the first embodiment.

### Fourth Embodiment

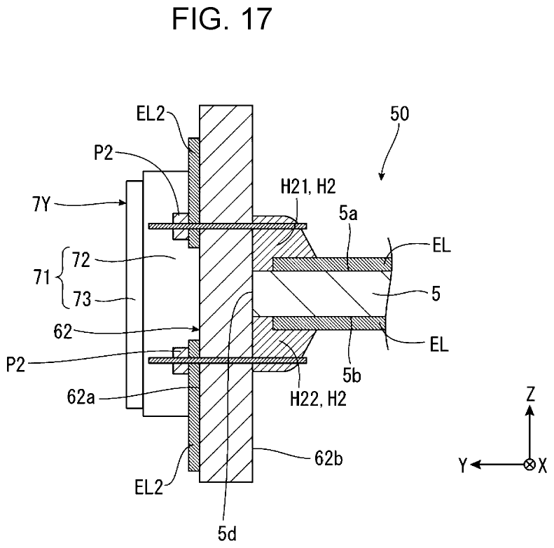

FIG. 16 is a cross-sectional view of a first relay substrate according to a fourth embodiment. FIG. 17 is a cross-sectional view of a second relay substrate according to the fourth embodiment.

The present embodiment is the same as the first embodiment described above, except that a configuration of a sensor substrate 50 is different. In the following description, differences between the present embodiment and the first embodiment described above will be mainly described, and a description of the similar matters will be omitted. In addition, in each drawing of the present embodiment, the same components as those in the above-described embodiment are denoted by the same reference numerals.

As illustrated in FIG. 16, in the sensor substrate 50 of the present embodiment, a first relay substrate 61 and a substrate 5 are electrically connected by a plurality of first pin headers P1. Specifically, in the present embodiment, a wiring EL1 is not formed on a back surface 61b of the first relay substrate 61. Further, the plurality of first pin headers P1 electrically connected to the wiring EL1 formed on a front surface 61a are arranged while penetrating through the first relay substrate 61. Then, the first relay substrate 61 and the substrate 5 are electrically connected by bonding a portion of the first pin header P1 that protrudes from the back surface 61b to a solder H1. With such a configuration, the wiring EL1 can be omitted from the back surface 61b of the first relay substrate 61, so that a configuration of the first relay substrate 61 is simplified.

Similarly, as illustrated in FIG. 17, in the sensor substrate 50 of the present embodiment, a second relay substrate 62 and a substrate 5 are electrically connected by a plurality of second pin headers P2. Specifically, in the present embodiment, a wiring EL2 is not formed on a back surface 62b of the second relay substrate 62. Further, the plurality of second pin headers P2 electrically connected to the wiring EL2 formed on a front surface 62a are arranged while penetrating through the second relay substrate 62. Then, the second relay substrate 62 and the substrate 5 are electrically connected by bonding a portion of the second pin header P2 that protrudes from the back surface 62b to a solder H2. With such a configuration, the wiring EL2 can be omitted from the back surface 62b of the second relay substrate 62, so that a configuration of the second relay substrate 62 is simplified.

The sensor module 1 as described above includes the first pin header P1 arranged while penetrating through the first relay substrate 61 and electrically connected to the solder H1, and the second pin header P2 arranged while penetrating through the second relay substrate 62 and electrically connected to the solder H2. With such a configuration, the wiring EL1 can be omitted from the back surface 61b of the first relay substrate 61, so that the configuration of the first relay substrate 61 is simplified. Similarly, the wiring EL2 can be omitted from the back surface 62b of the second relay substrate 62, so that the configuration of the second relay substrate 62 is simplified.

The fourth embodiment as described above can also achieve the same effect as the first embodiment.

The sensor module of the present disclosure has been described above based on the illustrated embodiments, but the present disclosure is not limited thereto, and a configuration of each part can be replaced with any configuration having a similar function. Any other component may be added to the present disclosure. The embodiments may also be combined as appropriate.

What is claimed is:

1. A sensor module comprising:
a substrate having a first surface and a second surface that are in a front-back relationship with each other, and side surfaces including a first side surface;
a first relay substrate having a first front surface and a first back surface and mounted on the first side surface with the first back surface facing the first side surface, the first front surface and the first back surface being in a front-back relationship with each other; and
a first inertial sensor including a first package mounted on the first front surface of the first relay substrate and a first sensor element housed in the first package,
wherein α1>α2>α3, in which a thickness direction of the substrate is a first direction, α1 represents a linear expansion coefficient of the substrate in the first direction, α2 represents a linear expansion coefficient of the first relay substrate in the first direction, and α3 represents a linear expansion coefficient of the first package in the first direction.

2. The sensor module according to claim 1, wherein the side surfaces of the substrate further include a second side surface different from the first side surface,
the sensor module further comprises:
a second relay substrate having a second front surface and a second back surface and mounted on the second side surface with the second back surface facing the second side surface, the second front surface and the second back surface being in a front-back relationship with each other; and
a second inertial sensor including a second package mounted on the second front surface of the second relay substrate and a second sensor element housed in the second package, and
α1>α4>α5, in which α4 represents a linear expansion coefficient of the second relay substrate in the first direction, and α5 represents a linear expansion coefficient of the second package in the first direction.

3. The sensor module according to claim 1, further comprising a third inertial sensor mounted on the first surface or the second surface of the substrate.

4. The sensor module according to claim 2, wherein the first relay substrate protrudes from the first side surface toward the first surface and the second surface in plan view of the first side surface, and
the second relay substrate protrudes from the second side surface toward the first surface and the second surface in plan view of the second side surface.

5. The sensor module according to claim 2, wherein the first inertial sensor is arranged at a distance from the first side surface in plan view of the first side surface, and
the second inertial sensor is arranged at a distance from the second side surface in plan view of the second side surface.

6. The sensor module according to claim 2, wherein the first relay substrate is electrically connected to the substrate via a first conductive portion, and
the second relay substrate is electrically connected to the substrate via a second conductive portion.

7. The sensor module according to claim 6, further comprising:
a first pin header arranged while penetrating through the first relay substrate and electrically connected to the first conductive portion; and
a second pin header arranged while penetrating through the second relay substrate and electrically connected to the second conductive portion.

8. The sensor module according to claim 2, wherein the side surfaces of the substrate further include a third side surface facing the first side surface, and a fourth side surface facing the second side surface, and
the sensor module further comprises:
a third relay substrate having a third front surface and a third back surface and mounted on the third side surface with the third back surface facing the third side surface, the third front surface and the third back surface being in a front-back relationship with each other;
a third inertial sensor mounted on the third front surface of the third relay substrate;
a fourth relay substrate having a fourth front surface and a fourth back surface and mounted on the fourth side surface with the fourth back surface facing the fourth side surface, the fourth front surface and the fourth back surface being in a front-back relationship with each other; and
a fourth inertial sensor mounted on the fourth front surface of the fourth relay substrate.

9. A sensor module comprising:
a substrate having a first surface and a second surface that are in a front-back relationship with each other, and side surfaces including a first side surface;
a first relay substrate having a first front surface and a first back surface and mounted on the first side surface with the first back surface facing the first side surface, the first front surface and the first back surface being in a front-back relationship with each other; and
a first inertial sensor including a first package mounted on the first front surface of the first relay substrate and a first sensor element housed in the first package.
